(19) United States
(12) Patent Application Publication
(10) Pub. No.: US 2005/0099883 A1
(43) Pub. Date: May 12, 2005

(54) Chemical solution mixing system and method of mixing chemical solutions

(76) Inventor: Young-Man Choi, Gyeonggi-do (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/984,818

(22) Filed: Nov. 10, 2004

(30) Foreign Application Priority Data
Nov. 10, 2003 (KR) 2003-78958

(51) Int. Cl. B01F 15/04

(52) U.S. Cl. 366/152.2; 366/153.1; 366/162.1

(57) ABSTRACT

A chemical mixing device includes a first supply line adapted to supply a first chemical solution, a second supply line adapted to supply a second chemical solution, a mixing vessel adapted to receive the first and second chemical solutions and to hold a mixing vessel chemical solution, a floating body disposed within the mixing vessel and adapted to rise to a level corresponding to a volume of the mixing vessel chemical solution; and a plurality of switches each adapted to provide a corresponding chemical solution supply measuring signal in response to the level of the floating body being equal to a corresponding fixed level, each of the fixed levels corresponding to a fixed volume of the mixing vessel chemical solution within the mixing vessel.

### CROSS REFERENCE TO RELATED APPLICATIONS

This application claims priority under 35 U.S.C. §119 from Korean Patent Application 2003-78958, filed on Nov. 10, 2003, the contents of which are hereby incorporated by reference in their entirety for all purposes as if fully set forth herein.

### BACKGROUND OF THE INVENTION

1. Technical Field

The present invention relates to the manufacturing of semiconductor devices, and more particularly, to a chemical mixing system for mixing chemical solutions used in the manufacturing the semiconductor devices.

2. Description

A semiconductor device manufacturing process generally contains a step of mixing H₂O₂ or deionized water with two or more different kinds of chemical solutions in a predetermined ratio in a chemical supply device. The semiconductor device manufacturing process has become more complicated with higher integration causing changes in the process conditions, which means the mixing ratio of chemicals are continuously changed.

FIG. 1 is a block diagram of a chemical mixing system for use in a semiconductor device manufacturing process according to the conventional art.

Referring to FIG. 1, the configuration of the chemical mixing system is as follows.

A measurement tank 10 stores a predetermined amount of first chemical solution A. A first level sensor 28 installed within measurement tank 10 measures a volume amount of a first chemical solution A. A first supply line 30 supplies measurement tank 10 with first chemical solution A. A first valve 14 installed in first supply line 30 opens or closes to supply or cut off, respectively, first chemical solution A. A first gas line 32 connected to measurement tank 10 supplies N2 gas to measurement tank 10. A second valve 16 installed in first gas line 32 supplies or cuts off the N2 gas. A third valve 18, installed in a first exhaust line 34, discharges first chemical solution A stored in measurement tank 10. A third supply line 38 supplies first chemical solution A stored in measurement tank 10 to a mixing vessel 12 when N2 gas is supplied.

A second supply line 36 supplies a second chemical solution B to mixing vessel 12. A fourth valve 20, installed in a second supply line 36 opens or closes to supply or cut off, respectively, second chemical solution B. Mixing vessel 12 receives and mixes first and second chemical solutions A and B. A second gas line 40 is connected to mixing vessel 12 to supply N2 gas. A sixth valve 24, installed in second gas line 40 supplies or cut offs the N2 gas to mixing vessel 12. A seventh valve 26, installed in a second exhaust line 42, discharges mixed chemical solution from mixing vessel 12. A fourth supply line 44, installed below mixing vessel 12, supplies the mixed chemical solution from mixing vessel 12. A fifth valve 22, installed in fourth supply line 44, controls the supply of the mixed chemical solution from mixing vessel 12.

A controller 46 outputs first, second, third, fourth, fifth, sixth, and seventh valve control signals, and ensures that the chemical solution is mixed by a predetermined ratio and the mixed chemical solution is supplied to a process chamber (not shown). Herewith, the first valve control signal is a signal for supplying a fixed quantity (volume) of first chemical solution A to the measurement tank 10. The fourth valve control signal is a signal for supplying a fixed quantity (volume) of second chemical solution B to mixing vessel 12. The second valve control signal is a signal for purging first chemical solution A from measurement tank 10. The third valve control signal is a signal for discharging first chemical solution A from measurement tank 10. The sixth valve control signal is a signal for purging the mixed chemical solution from mixing vessel 12. The seventh valve control signal is a signal for discharging the mixed chemical solution from mixing vessel 12. The fifth valve control signal is a signal for supplying the mixed chemical solution from mixing vessel 12.

Beneficially, the first through seventh valves 14, 16, 18, 20, 22, 24, 26 are solenoid valves.

First and second chemical solutions A and B are supplied through first and second supply lines 30, 36, respectively. Controller 46 outputs the first and fourth valve control signals so as to open first and fourth valves 14, 20, respectively, and to supply first chemical solution A to measurement tank 10 and supply second chemical solution B to mixing vessel 12. At this time, first level sensor 28 measures a predetermined volume of first chemical solution A in measurement tank 10, and second level sensor 29 measures a filled state when second chemical solution B supplied to the mixing vessel 12 is filled to a predetermined level therein. The installation position of first and second level sensors 28, 29 is varied by the desired mix ratio of the chemical solution. The level measurement signals of the first and second level sensors 28, 29 are provided to controller 46.

Controller 46 outputs the first valve control signal to close first valve 14 when first level sensor 28 senses a desired measurement tank 10 level. First valve 14 cuts off the supply of first chemical solution A supplied to measurement tank 10. Accordingly, first chemical solution A is supplied in a predetermined amount by installing first level sensor 28 in measurement tank 10. Additionally, a level sensor may be installed above first level sensor 28 so that controller 46 can sense whenever first chemical solution A is filled into measurement tank 10 above a predetermined volume. In that case, controller 46 outputs the third valve control signal to open third valve 18 and discharge from measurement tank 10 first chemical solution A, filled above the predetermined volume.

Controller 46 outputs the fourth valve control signal to close fourth valve 20 when second level sensor 29 senses a desired level in mixing vessel 12. Fourth valve 20 cuts off the supply of second chemical solution B into mixing vessel 12. Accordingly, second chemical solution B is supplied in a predetermined volume by installing second level sensor 29 in mixing vessel 12. Additionally, a level sensor may be installed above the second level sensor 29 so that controller 46 can sense whenever the second chemical solution B is filled into mixing vessel 12 above a predetermined volume. In that case, controller 46 outputs the seventh valve control signal to open seventh valve 26 and discharge from mixing vessel 12 second chemical solution B, filled above the predetermined volume.

Controller 46 outputs the second valve control signal so as to open second valve 16 and supply N2 gas to first gas line 32. The N2 gas is provided to measurement tank 10 through gas line 32 so that first chemical solution A in measurement tank 10 is supplied (discharged) to mixing vessel 12 through third supply line 38.

Controller 46 cuts off second valve 16 when first chemical solution A is all discharged to mixing vessel 12. At that point, mixing vessel 12 has a mixed chemical solution of first chemical solution A and second chemical solution B. Subsequently, controller 46 outputs the fifth and sixth valve control signals to open fifth and sixth valves 22, 24. When sixth valve 24 is opened N2 gas is supplied to sixth gas line 40 so that the mixed chemical solution is purged through fourth supply line 44. The mixed chemical solution output through fourth supply line 44 is supplied to a process chamber (not shown) through fifth valve 22.

The chemical supply device or wet station employed in the conventional semiconductor manufacturing process must continuously change the mixed chemical conditions, such as the type of chemicals, concentration, etc. as the process conditions change. It is difficult to meet the constant change in requirements because the chemical supply device, or wet station, mixes chemicals by using a level sensor or metering pump. Thus, the structure and program of the mixing device must be changed according to a change in chemicals and their mixing ratio. Furthermore, a complicated procedure is required in order to check whether or not the mixing operation is performed by an exact ratio whenever the mixing ratio is changed, which requires a lot of time.

The chemical mixing device according to the conventional art as shown in FIG. 1 requires a specific measurement tank in order to mix several different kinds of chemicals, which requires large complicated structures taking up a lot installation space.

Furthermore, the life span of a level sensor for measuring the chemical solution is limited, and an error in the chemical mixture may be caused by a breakdown of the level sensor. The chemical mixing device requires the use of a meter, such as a precise densitometer, to measure the mixing ratio. But this type of meter is not suitable for measuring a mixture of three more different chemicals that are necessary for a highly integrated semiconductor device manufacturing process. That is, it is difficult to accurately measure the mix ratio.

Accordingly, it would be desirable to provide a chemical mixing system capable of accurately measuring chemicals. It would also be desirable to provide such a system which can prevent mixing errors of chemicals caused by sensor defects. It would further be desirable to provide a system which requires less installation space.

### SUMMARY OF THE INVENTION

According to one aspect of the invention, a chemical mixing device includes a first supply line adapted to supply a first chemical solution; a second supply line adapted to supply a second chemical solution; a mixing vessel adapted to receive the first and second chemical solutions from the first and second supply lines and to hold a mixing vessel chemical solution comprising one or more of the first and second chemical solutions; a floating body disposed within the mixing vessel and adapted to rise to a level corresponding to a volume of the mixing vessel chemical solution within the mixing vessel; and a plurality of switches each adapted to provide a corresponding chemical solution supply measuring signal in response to the level of the floating body being equal to a corresponding fixed level, each of the fixed levels corresponding to a fixed volume of the mixing vessel chemical solution within the mixing vessel.

Beneficially, the device also includes supply valves installed individually in the supply lines which are opened or closed so as to respectively supply or cut off supply of different chemical solutions in response to a valve control signal. The mixing vessel receives and mixes the different type of chemical solutions supplied through supply lines. The mixing vessel supplies mixed chemical solution from the mixing vessel to the process chamber via a mixed-chemical supply line which is beneficially installed below the mixing vessel. Beneficially, a mixed-chemical supply valve is installed in the mixed-chemical supply line and supplies the mixed chemical solution in response to valve control signal. Beneficially, a measurement rod is fixed to floating body, and moves vertically in order to measure a quantity of the chemical solutions supplied to the mixing vessel. The switches are sequentially switched by the vertical movement of measurement rod, to thus output the chemical solution supply measurement signals. Also beneficially, a controller receives the chemical supply measurement signals from the switches in conformity with a predetermined mixing ratio of the chemical solutions, and outputs valve control signals for individually supplying different kinds of chemical solutions by a fixed quantity and a valve control signal for supplying the mixed chemical solution to the process chamber.

Beneficially, the chemical mixing device further includes a measurement rod fixing part for fixing the measurement rod and simultaneously moving the measurement rod horizontally, and then lowering it so as not to contact with switches, when the solution mixed within the mixing vessel is supplied to the process chamber.

Beneficially, the chemical mixing device further includes at least two flow meters for respectively indicating a supply quantity of the different kinds of chemical solutions supplied through the at least two supply lines.

According to another aspect of the invention, A method of mixing chemical solutions comprises: supplying a first chemical solution to a mixing vessel; stopping supplying the first chemical solution to the mixing vessel in response to a floating body within the mixing vessel rising to a first fixed level; supplying a second chemical solution to the mixing vessel in response to the floating body within the mixing vessel rising to the first fixed level; and stopping supplying the second chemical solution to the mixing vessel in response to the floating body within the mixing vessel rising to a second fixed level.

Another to yet another aspect of the invention, a chemical solution mixing system comprises: a plurality of supply lines each adapted to supply a corresponding supplied chemical solution; a mixing vessel adapted to receive the supplied chemical solutions from the plurality of supply lines and to hold a mixing vessel chemical solution comprising one or more of the supplied chemical solutions; and a plurality of switches each adapted to provide a corresponding chemical solution supply measuring signal in response to a volume of the mixing vessel chemical solution within the mixing vessel reaching a corresponding fixed level.

### BRIEF DESCRIPTION OF THE DRAWINGS

The present invention will become more fully understood from the detailed description given hereinbelow and the accompanying drawings which are given by way of illustration only, and wherein:

FIG. 1 is a block diagram of a chemical mixing system for use in a semiconductor manufacturing process according to the prior art; and

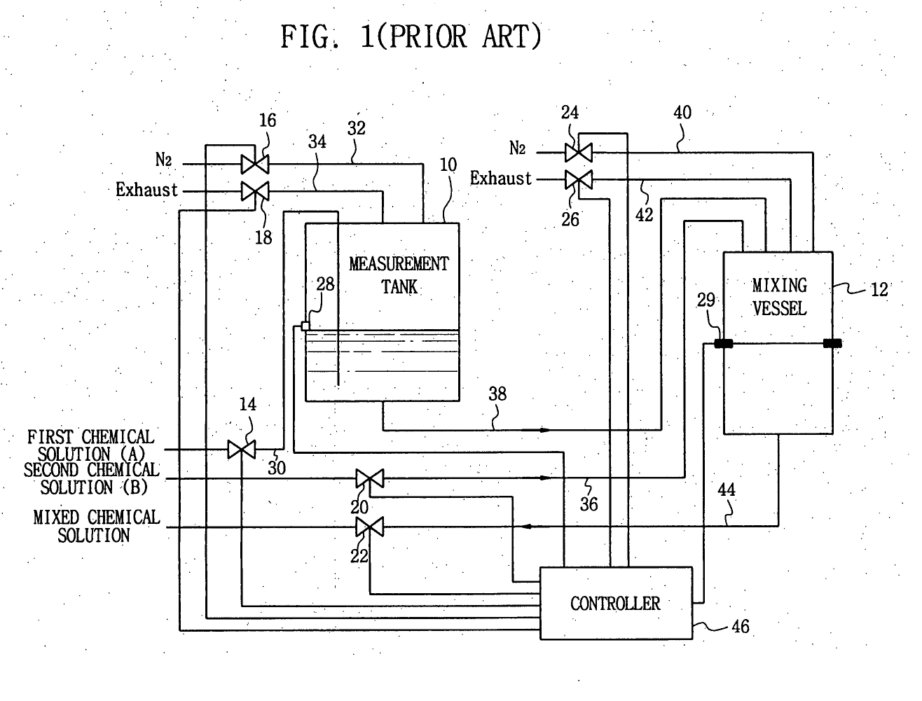

FIG. 2 is a block diagram of one embodiment of a chemical mixing system according to one or more aspects of the invention.

### DETAILED DESCRIPTION

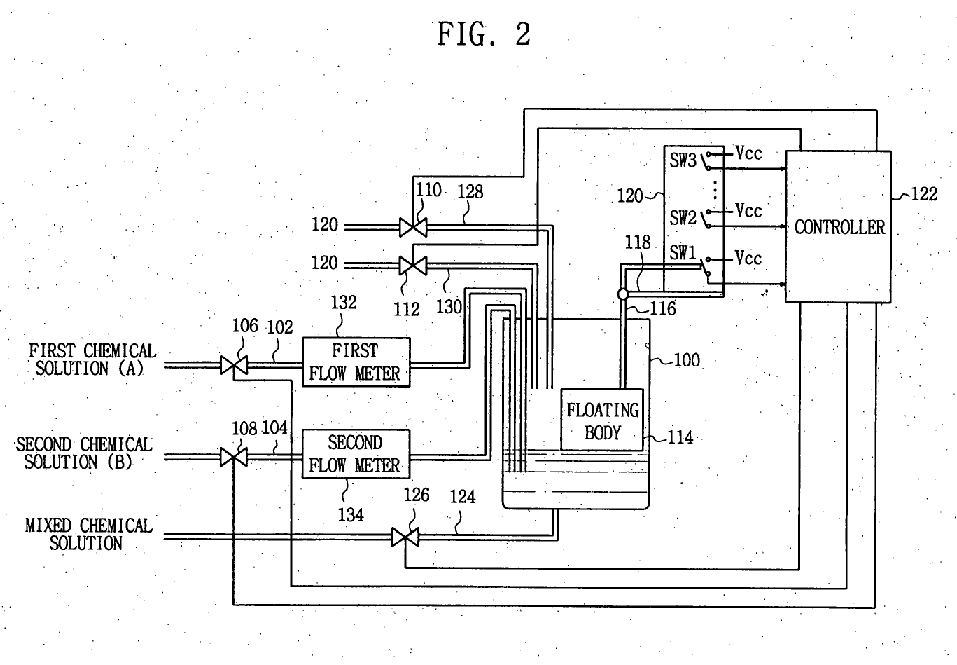

Hereinafter, exemplary embodiments of the present invention will be described in detail with reference to FIG. 2. It will be understood by those skilled in the art that the present invention can be embodied by numerous different ways and is not limited to the following described embodiments. The following various embodiments are exemplary in nature. For purposes of brevity, a detailed description of known functions and systems has been omitted.

FIG. 2 is a block diagram of chemical mixing system. The chemical mixing system has the following configuration.

A first supply line 102 supplies a first chemical solution A. A first (supply) valve 106, installed in first supply line 102, opens or closes to supply or cut off, respectively, first chemical solution A in response to a first valve control signal.

A second supply line 104 supplies a second chemical solution B. A second (supply) valve 108, installed in second supply line 104, opens or closes to supply or cut off, respectively, second chemical solution B in response to a second valve control signal.

A mixing vessel 100 receives and mixes first and second chemical solutions A and B supplied through first and second supply lines 102, 104, respectively and holds a mixing vessel chemical solution comprising one or both of the first and second chemical solutions, depending at any given time upon whether one or both of the first and second chemical solutions have already been supplied to the mixing vessel.

A gas line 128, connected to mixing vessel 100, supplies N2 or another gas to mixing vessel 100. A third valve 110, installed in gas line 128, supplies or cut offs the N2 gas in response to a third valve control signal.

A fourth valve 112, installed in an exhaust line 130, exhausts a mixed chemical solution from mixing vessel 100 in response to a fourth valve control signal.

A fifth valve 126, installed in a third supply line 124, supplies mixed chemical solution to a process chamber (not shown) in response to fifth valve control signal.

A floating body 114 is installed within mixing vessel 100 and is adapted to move correspondingly to a volume of chemical solutions within mixing vessel 100.

A measurement rod 116 fixed to floating body 114, moves up and down in order to measure the quantity of the chemical solution in mixing vessel 100.

A switching part 120 is sequentially switched on by the movement of measurement rod 116 based on the volume of the chemical solution, to thus output a measurement signal for the chemical solution.

A controller 122 receives a chemical quantity measurement signal from switching part 120 in conformity with a predetermined mixing ratio of the mixed chemical solution, and outputs first, second, third, and fourth valve control signals, controls the mixing of the chemical solutions based on a predetermined ratio, and supplies the mixed chemical solution to a process chamber (not shown).

Herewith, the first valve control signal is a signal for supplying a fixed quantity (volume) of the first chemical solution A. The second valve control signal is a signal for supplying a fixed quantity (volume) of the second chemical solution B. The third valve control signal is a signal for purging the mixed chemical solution from mixing vessel 100. The fourth valve control signal is a signal for discharging the mixed chemical solution from mixing vessel 100 to the process chamber (not shown).

A measurement rod fixing part 118 fixes measurement rod 116 and simultaneously moves the measurement rod 116 horizontally and then lowers it so as not to contact switching part 120 when the solution mixed within the mixing vessel 100 is supplied to the process chamber.

A first flow meter 132 measures a supply quantity of the first chemical solution A supplied through first supply line 102.

A second flow meter 134 measures a supply quantity of the second chemical solution B supplied through second supply line 104.

Beneficially, first through fifth valves 106, 108, 110, 112, and 126 may be solenoid valves.

Switching part 120 is configured to individually measure supply-quantities of several types of chemical solutions by using, for example, numerous limit switches.

In another embodiment, a chemical mixing device includes at least two supply lines, a mixing vessel, a mixed-chemical supply line, a chemical supply quantity measuring part and a controller.

Herewith, the at least two supply lines supply different chemical solutions. The mixing vessel receives and mixes the different chemical solutions supplied through the supply lines. The mixed-chemical supply line is installed below the mixing vessel and supplies the mixed chemical solution from the mixing vessel to a process chamber. The chemical supply quantity measuring part moves to an upper side by a supply of the chemical solutions within the mixing vessel, and sequentially measures several kinds of chemical supply quantities supplied sequentially through use of a floating body installed within the mixing vessel. The controller stops the supply of the chemical solution whenever a chemical supply quantity measurement signal is sensed from the chemical supply quantity measuring part in conformity with a predetermined mixing ratio of chemical solutions, and then respectively supplies different kinds of chemical solutions to the mixing vessel by a predetermined quantity.

The operation of the system shown in FIG. 2 will be described as follows.

First and second chemical solutions A and B are supplied through first and second supply lines 102, 104, respectively. Controller 122 outputs the first valve control signal to open first valve 106 to supply first chemical solution A to mixing vessel 100. Next, first flow meter 132 measures a supplied quantity of first chemical solution A supplied through first supply line 102.

At this time, floating body 114 rises as first chemical solution A is filled into mixing vessel 100. Floating body 114 floats on the surface of the chemical solution. As floating body 114 rises to a predetermined level, measurement rod 116 connected to floating body 114 enables a first switch SW1 of switching part 120 to trigger. When first switch SW1 is triggered, controller 122 senses that a predetermined quantity of first chemical solution A is filled into mixing vessel 100. Then, controller 122 outputs the first valve control signal to shut off first valve 106; controller 122 also outputs the second valve control signal to open second valve 108, so that second chemical solution B can be supplied to mixing vessel 100. Subsequently, second flow meter 134 measures a supplied quantity of second chemical solution B supplied through second supply line 104.

At this time, floating body 114 rises as second chemical solution B is filled into mixing vessel 100. As floating body 114 once again rises, to a next predetermined level in mixing vessel 100, measurement rod 116 enables a second switch SW2 of switching part 120 to trigger. When second switch SW2 is triggered, controller 122 senses that a predetermined quantity of second chemical solution B is filled into mixing vessel 100. Then, controller 122 outputs the second valve control signal to shut off second valve 108. Next, controller 122 outputs the third and fifth valve control signals to open third and fifth valves 110, 126, respectively. The chemical solution mixed in mixing vessel 100 is thus supplied to a process chamber by the opening of third and fifth valves 110, 126.

As described above, first switch SW1 of switching part 120 senses a supplied state of first chemical solution A, and second switch SW2 senses second chemical solution B. However, it is also possible that first switch SW1 senses a supply state of first chemical solution A, and second switch SW2 senses whether first chemical solution A is filled above a predetermined volume. In that case, controller 122 can output fourth valve control signal to open fourth valve 112 to exhaust from mixing vessel 100, first chemical solution A filled over the predetermined volume.

Accordingly, first chemical solution A and second chemical solution B are mixed in mixing vessel 100 by a predetermined ratio.

In the specific example described above and specifically illustrated in FIG. 2, two different chemical solutions are mixed in the mixing vessel 100. However, the principles can be easily adapted to mix three, four, or more chemical solutions. In that case, the system of FIG. 2 is modified as appropriate to add additional supply lines, valves, and flow meters corresponding to the number of chemical solutions to be mixed. In that case, first chemical solution A is first supplied to mixing vessel 100 and then a predetermined quantity of first chemical solution A is sensed by switch SW1 when floating body 114 has risen to a first predetermined level. Next, second chemical solution B is supplied to mixing vessel 100, and floating body 114 rises to a second predetermined level to turn on switch SW2. Thus a predetermined quantity of second chemical solution B is supplied to mixing vessel 100. Also, a third chemical solution C can be supplied to mixing vessel 100, and floating body 114 rises to trigger a switch SW3. Thus a predetermined quantity of third chemical solution C is supplied to mixing vessel 100. Subsequently, a fourth chemical solution D can be supplied to mixing vessel 100, and floating body 114 rises to trigger switch SW4. Thus a predetermined quantity of fourth chemical solution is supplied to mixing vessel 100. Hence, controller 122 controls the supply of the first through fourth chemical solutions to mixing vessel 100 to mix them. Then controller 122 also controls fifth valve 126 so that it is opened by the fifth valve control signal to supply the mixed chemical solution. Herewith, switches SW1˜SWn of switching part 120 are respectively installed at appropriate positions correspondingly to a desired, or predetermined, mixing ratio of chemical solutions.

It will be apparent to those skilled in the art that modifications and variations can be made in the present invention without deviating from the spirit or scope of the invention. Thus, it is intended that the present invention cover any such modifications and variations of this invention provided they come within the scope of the appended claims and their equivalents. Accordingly, these and other changes and modifications are seen to be within the true spirit and scope of the invention as defined by the appended claims.

1. A chemical solution mixing system, comprising:
a first supply line adapted to supply a first chemical solution;
a second supply line adapted to supply a second chemical solution;
a mixing vessel adapted to receive the first and second chemical solutions from the first and second supply lines and to hold a mixing vessel chemical solution comprising one or more of the first and second chemical solutions;
a floating body disposed within the mixing vessel and adapted to rise to a level corresponding to a volume of the mixing vessel chemical solution within the mixing vessel; and
a plurality of switches each adapted to provide a corresponding chemical solution supply measuring signal in response to the level of the floating body being equal to a corresponding fixed level, each of the fixed levels corresponding to a fixed volume of the mixing vessel chemical solution within the mixing vessel.

2. The system of claim 1, further comprising a controller adapted to receive the chemical solution supply measuring signals from the plurality of switches and in response thereto to control the supply of the first and second chemical solutions by the first and second supply lines.

3. The system of claim 2, further comprising:
a first supply valve provided in the first supply line; and
a second supply valve provided in the second supply line,
wherein the controller provides a first valve control signal to the first supply valve and a second valve control signal to the second supply valve.

4. The system of claim 3, wherein the first valve control signal opens the first supply valve to supply the first chemical solution to the mixing vessel, and shuts off the first supply valve in response to the controller receiving the chemical solution supply measuring signal from a first one of the plurality of switches.

5. The system of claim 4, wherein the second valve control signal opens the second supply valve to supply the second chemical solution to the mixing vessel in response to the controller receiving the chemical solution supply measuring signal from the first one of the plurality of switches, and shuts off the second supply valve in response to the controller receiving the chemical solution supply measuring signal from a second one of the plurality of switches.

6. The system of claim 1, further comprising a measurement rod connected to the floating body and being adapted to switch the plurality of switches in response to the level of the floating body.

7. The system of claim 1, further comprising:
a first flow meter provided in the first supply line; and
a second flow meter provided in the second supply line.

8. A method of mixing chemical solutions, comprising:
supplying a first chemical solution to a mixing vessel;
stopping supplying the first chemical solution to the mixing vessel in response to a floating body within the mixing vessel rising to a first fixed level;
supplying a second chemical solution to the mixing vessel in response to the floating body within the mixing vessel rising to the first fixed level; and
stopping supplying the second chemical solution to the mixing vessel in response to the floating body within the mixing vessel rising to a second fixed level.

9. The method of claim 8, further comprising:
supplying a third chemical solution to the mixing vessel in response to the floating body within the mixing vessel rising to the second fixed level; and
stopping supplying the third chemical solution to the mixing vessel in response to the floating body within the mixing vessel rising to a third fixed level.

10. The method of claim 8, wherein the first chemical solution is supplied from a first supply line and the second chemical solution is supplied from a second supply line.

11. The method of claim 10, wherein supplying the first chemical solution to the mixing vessel comprises providing a first valve control signal to a first supply valve provided in the first supply line to open the first supply valve, and wherein stopping supplying the first chemical solution to the mixing vessel comprises providing the first valve control signal to the first supply valve to shut off the first supply valve.

12. The method of claim 11, wherein the first valve control signal shuts off the first supply valve in response to a first chemical solution supply measuring signal from a first switch activated in response to the floating body within the mixing vessel rising to the first fixed level.

13. The method of claim 12, wherein supplying the second chemical solution to the mixing vessel comprises providing a second valve control signal to a second supply valve provided in the second supply line to open the second supply valve, and wherein stopping supplying the second chemical solution to the mixing vessel comprises providing the second valve control signal to the second supply valve to shut off the second supply valve.

14. The method of claim 13, wherein the second valve control signal shuts off the second supply valve in response to a second chemical solution supply measuring signal from a second switch activated in response to the floating body within the mixing vessel rising to the second fixed level.

15. A chemical solution mixing system, comprising:
a plurality of supply lines each adapted to supply a corresponding supplied chemical solution;
a mixing vessel adapted to receive the supplied chemical solutions from the plurality of supply lines and to hold a mixing vessel chemical solution comprising one or more of the supplied chemical solutions; and
means for providing a plurality of chemical solution supply measuring signals in response to a volume of the mixing vessel chemical solution within the mixing vessel reaching a corresponding plurality of fixed levels.

16. The system of claim 15, further comprising a controller adapted to receive the chemical solution supply measuring signals from the plurality of switches and in response thereto to control the supply of the supplied chemical solutions from the plurality of supply lines.

17. The system of claim 16, further comprising:
a floating body disposed within the mixing vessel and adapted to rise to a level corresponding to the volume of the mixing vessel chemical solution within the mixing vessel; and
a measurement rod connected to the floating body and being adapted to switch the plurality of switches in response to the level of the floating body.

18. The system of claim 16, further comprising a plurality of supply valves, each of the supply valves being provided in a corresponding one of the plurality of supply lines, wherein the controller provides a plurality of valve control signals, each of the valve control signals being provided to a corresponding one of the plurality of supply valves.

19. The system of claim 18, wherein each valve control signal shuts off the corresponding supply valve in response to the controller receiving a corresponding one of the chemical solution supply measuring signals from one of the plurality of switches.

20. The system of claim 15, further comprising a plurality of flow meters each provided in corresponding one of the plurality of supply lines.
